(19) United States
(12) Patent Application Publication
(10) Pub. No.: US 2010/0161309 A1
(43) Pub. Date: Jun. 24, 2010

(54) Apparatus and Methods Thereof for Configuration and Control of a System-On-Chip Emulation Platform

(75) Inventors: Alain Chartraire, Mougins (FR); Pascal Jullien, Vence (FR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: SCALEO CHIP, Valbonne (FR)

(21) Appl. No.: 12/342,672

(22) Filed: Dec. 23, 2008

(51) Int. Cl. G06F 9/455

(52) U.S. Cl. 703/28

(57) ABSTRACT

An apparatus, protocol and methods for configuration of a platform for prototyping and emulation of a system-on-chip (SOC) device. The apparatus is an extensible platform for configurable prototyping of SOCs using an integrated circuit board comprised of a configurable board controller and a plurality of configurable modules which implement the SOC functionality. A plurality of such platform boards may be linked together to provide emulation and prototyping functionality for a multi-core system. The protocol specifies the SOC platform configuration data, commands for configuration and reading and writing data to each module and the communications between the host computer and the platform. The apparatus uses methods for configurable execution of the configuration commands by the board controller, and for the preparation of the configuration specification by the host computer. The host computer provides a user interface for management of the configuration specification preparation.

### BACKGROUND OF THE INVENTION

1. Field of the Invention

The present invention relates generally to the configuration of prototyping platforms for a system-on-chip (SOC). More specifically, it relates to an apparatus and methods for specification and control of such configuration, and to a protocol for composing and communicating a configuration specification to a prototyping platform.

2. Prior Art

Modern system-on-chip (SOC) devices are used ubiquitously as embedded platforms, combining processing core, memory, firmware, configurable logic and configurable functional modules. The complexity of SOCs is increasing, driven by improvements in chip technology that enable the placement of more functional modules on the SOC with higher clock speeds. This complexity adds to the challenges of SOC hardware and software validation and debugging. Software-based simulations of SOC devices require complex software. Increasingly faster SOC devices have timing and real-time complexities and performance-related concerns that are not captured by such software-based simulations. Emulator-based systems also may not be sufficient for high-speed systems, and require the development of application specific hardware to properly test an SOC configuration.

Thus, the use of hardware prototypes is critical for validating the SOC hardware and software. Building application-specific prototypes for each configuration of the SOC is prohibitive in cost of development resources and time to market. A reconfigurable SOC prototyping platform is needed to address these requirements. The platform should comprise the standard components such as the processor core, memory and functional modules, and custom modules and logic such as programmable logic and custom IP modules. Standardization efforts such as Nexus 5001 provide a standard for message-based communications between prototyping platforms and host development tools. However, the standards do not address the specification and configuration of the platform.

Prototyping and hardware/software co-verification platforms using field programmable gate arrays (FPGAs) for implementation of logic and custom IP are a widely used solution for SOC prototyping. An FPGA-based SOC prototyping architecture has been proposed where each IP unit is implemented in the FPGA, together with interface logic for the IP unit. In such systems, a controller component is used to provide host communications and a JTAG interface. The SOC modules and their configuration are specified at the level of RTL for implementation in the FPGA. In addition a hierarchical configuration description for ARM-based systems has been described.

Thus, there is a need in the art to facilitate SOC prototyping though a general configuration specification supported through a prototyping platform and host computer tools, as well as methods thereof.

### BRIEF DESCRIPTION OF THE DRAWINGS

FIG. 1 is a block diagram of the system-on-a-chip prototyping platform, showing multiple SOC prototyping modules.

FIG. 2 is a detailed block diagram of an SOC module.

FIG. 3 is a schematic diagram showing the assembly of configuration commands into a concatenated SOC configuration file and to an encapsulated SOC configuration file.

FIG. 4 is a schematic diagram showing the execution of the concatenated SOC configuration file by the platform.

FIG. 5 is a schematic diagram showing the storage of the encapsulated SOC configuration file using NAND Flash.

FIG. 6 is a schematic diagram showing the structure of an SOC platform configuration command.

FIG. 7 is a schematic diagram showing the structure of an exemplary Data Download Init command to the NAND Flash for erasing 1 sector.

FIG. 8 is a schematic diagram showing the structure of an exemplary Data Download Init Data Download command sequence for writing data to the Clock Generation unit.

FIG. 9 is a flowchart of the Host Computer processing of the Data Download Init Data Download command sequence.

FIG. 10 is a sequence diagram showing the exchange of commands and responses between the Host Computer and the Board Controller.

FIG. 11 is a schematic diagram of the Board Controller in a preferred embodiment.

FIG. 12 is a sequence diagram showing an exemplary processing of configuration commands for the Clock Generator unit by the board controller software and hardware components.

### DETAILED DESCRIPTION OF THE PREFERRED EMBODIMENTS

An apparatus, protocol and methods for configuration of a platform for prototyping and emulation of a system-on-chip (SOC) device. The apparatus is an extensible platform for configurable prototyping of SOCs using an integrated circuit board comprised of a configurable board controller and a plurality of configurable modules that implement the SOC functionality. A plurality of such platform boards may be linked together to provide emulation and prototyping functionality for a multi-core system. The protocol specifies the SOC platform configuration data, commands for configuration and reading and writing data to each module and the communications between the host computer and the platform. The apparatus uses methods for configurable execution of the configuration commands by the board controller, and for the preparation of the configuration specification by the host computer. The host computer provides a user interface for management of the configuration specification preparation.

SOC devices are complex integrated circuits, comprising core processing modules, programmable logic modules such as FPGA, and a plurality of application specific functional modules. The development process for SOC-based applications comprising SOC hardware and software requires debugging, testing and prototyping for each application specific configuration of hardware and software. Simulation and emulation-based solutions are unable to completely capture the increasing complexity and processing speeds of current and anticipated SOC devices. Developments of application specific prototypes are prohibitive in cost and development time. Accordingly, the invention suggests a general, reusable and extensible platform and protocol for prototyping SOC devices. The invention is comprised of a board controller that implements a protocol enabling a general framework for configurable prototyping of SOC devices.

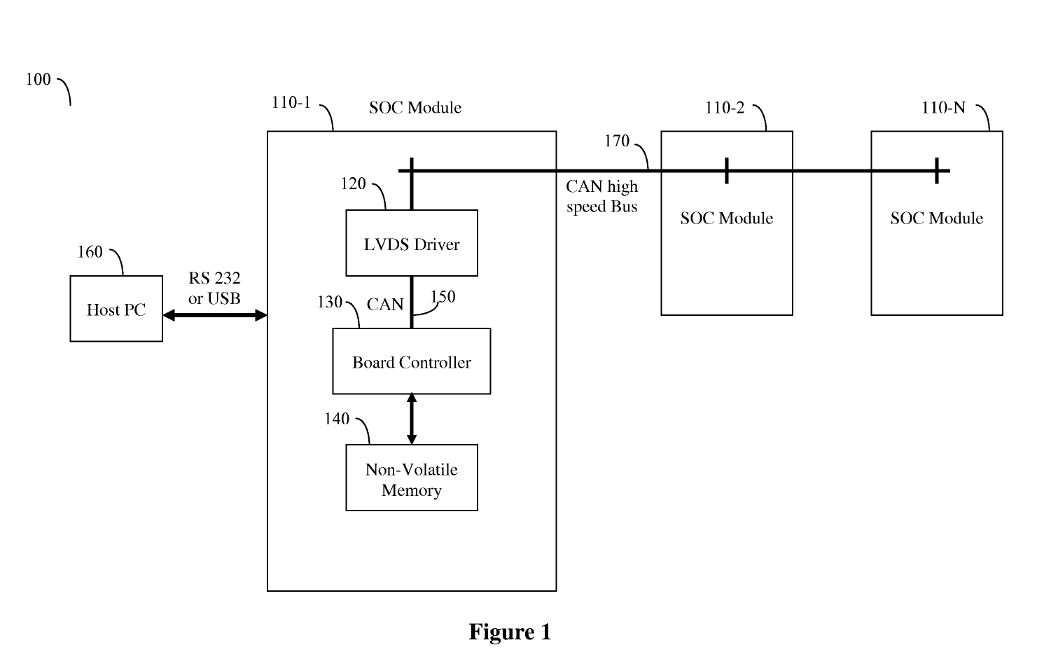

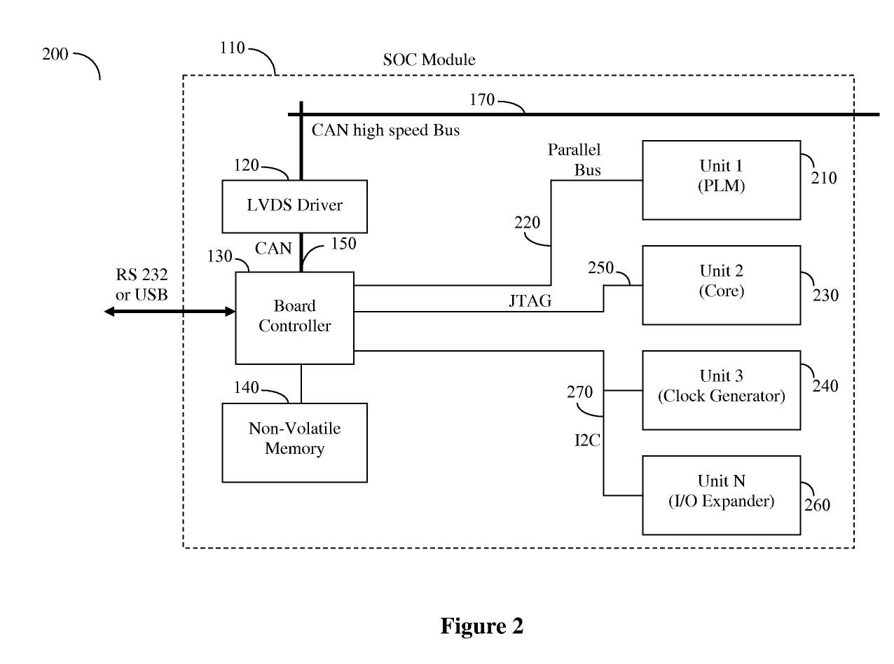

Reference is now made to FIG. 1 where an exemplary and non-limiting block diagram of the configurable SOC platform 100 is shown that may be implemented from monolithic semiconductor modules. This diagram shows a system 100, comprising the platform SOC Module 110-1. The SOC Module 110-1 is comprised of Board Controller 130, Low Voltage Differential Signaling (LVDS) Driver 120 facilitating connectivity over the Controller Area Network (CAN) high speed bus 150, and a non-volatile memory (NVM) 140, for example a NAND Flash. A communication link to the Host Computer (Host PC) 160 may use communications infrastructure and protocols such as RS-232, Universal Serial Bus (USB), Ethernet, and the likes. Additional SOC Modules 110-2 through 110-N may be linked together over the CAN high speed bus 170 for prototyping a multi-core SOC. A typical SOC Module is also comprised of a core module, programmable logic and functional modules explained in further detail with respect to FIG. 2.

Reference is now made to FIG. 2, where an exemplary and non-limiting block diagram of the SOC Module 200 is shown. In this diagram, an exemplary and non-limiting SOC Module 110 is shown in detail. The SOC Module 110 is comprised of Board Controller 130, which is responsible for the communications with the Host Computer, the interpretation and execution of the configuration commands, and for configuration management of the Core Module 230, Programmable Logic Module (PLM) 210 implemented, for example, by a field programmable gate array (FPGA), Non Volatile Memory 140, CAN Link 120 and exemplary modules, the Clock Generator 240 and the I/O Expander 260. The Board Controller is connected to the modules over several buses. The Board Controller has a parallel interface for standard interfacing to parallel bus 220, shown in exemplary use in this diagram for connection to parallel bus modules such as PLM 210. The Board Controller further has a Joint Test Action Group (JTAG) interface, based on IEEE standard 1149.1, for connection to JTAG ports 250, shown in exemplary use for standard interfacing Core Modules such as the exemplary Core Module 230. The Board Controller further has a bus master interface to the I2C bus (Inter-Integrated Circuit Bus) 270 for interfacing to programmable modules such as exemplary modules 240 and 260. It should be understood that other communication protocols may be used for these purposes without limiting the scope of the disclosed invention.

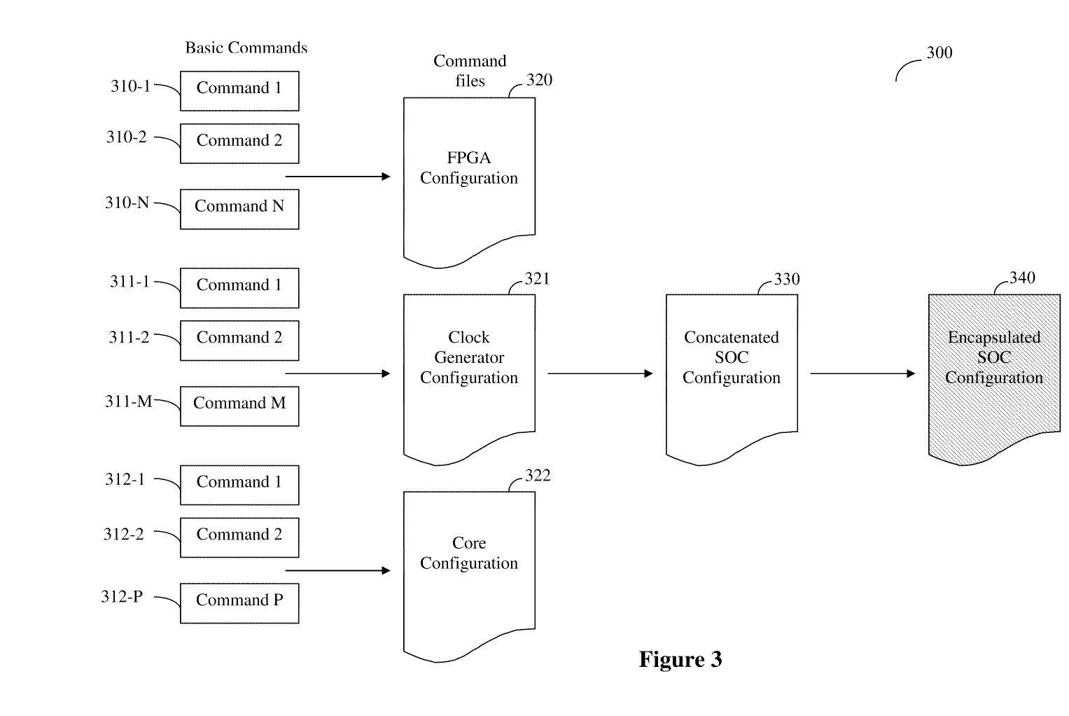

Reference is now made to FIG. 3, where a schematic diagram showing the assembly of configuration commands 300 is shown. Configurations commands for each module are assembled into Command Files. The diagram shows the exemplary commands 310-1, 310-2 through 310-N for configuration of the PLM 210, generated from RTL sources using standard FPGA compilation tools. These commands are assembled into the PLM 210 configuration file 320. Additionally, the diagram shows exemplary configuration commands 311-1, 311-2 through 311-M for configuration of the Clock Generation Module 240 which are assembled into configuration file 321. Additionally, the diagram shows the exemplary configuration commands 312-1, 312-2 through 312-P for configuration of the Core Module 230, such as for configuration of the Core Module 230 internal memory map, which are assembled into configuration 322. The configuration files 320, 321 and 322 are assembled into a concatenated SOC configuration file 330 for download to the platform Board Controller 130. Optionally, the Concatenated Configuration 330 can be encapsulated as an encapsulated SOC configuration file 340 for delivery to the Non Volatile Memory 140.

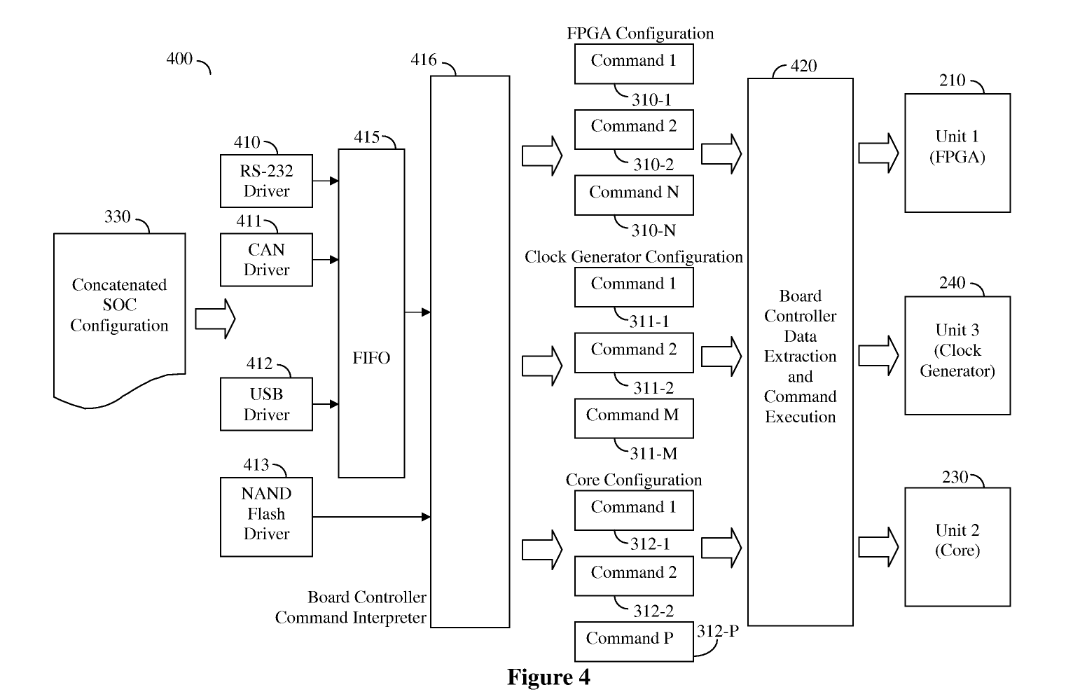

Reference is now made to FIG. 4, where a schematic diagram 400 showing the execution of the concatenated SOC configuration file 330 by the platform is shown. The concatenated SOC configuration file 330 is received over a communications link, such as, but not limited to, RS-232, CAN Bus or USB. The Board Controller interface to the communications link is controlled by an appropriate communications driver, such as the exemplary driver 410 for the RS-232 link, driver 411 for the CAN Bus, and driver 412 for the USB driver. These drivers handle the link protocol, and deliver the Concatenated SOC Configuration to FIFO 415. The Board Controller 130 uses the Board Controller Command Interpreter 416 to read the Concatenated SOC Configuration from the FIFO, and to disassemble the Configuration Commands. In the case where the concatenated SOC configuration file 330 is stored in the Non-Volatile Memory 140, the concatenated SOC configuration file 330 is read directly by the Board Controller Command Interpreter 416 via the NAND Flash Driver 413. The drawing 400 shows an exemplary set of commands, commands 310-1, 310-2 and 310-N for PLM 210 configuration, Commands 311-1, 311-2 and 311-M for Clock Generation Module 240 configuration and Commands 312-1, 312-2 and 312-P for Core Module 230 configuration. The Board Controller 130 uses the Board Controller Data Extraction and Command Execution 420 to extract the commands, and to process each command for configuration of each Module.

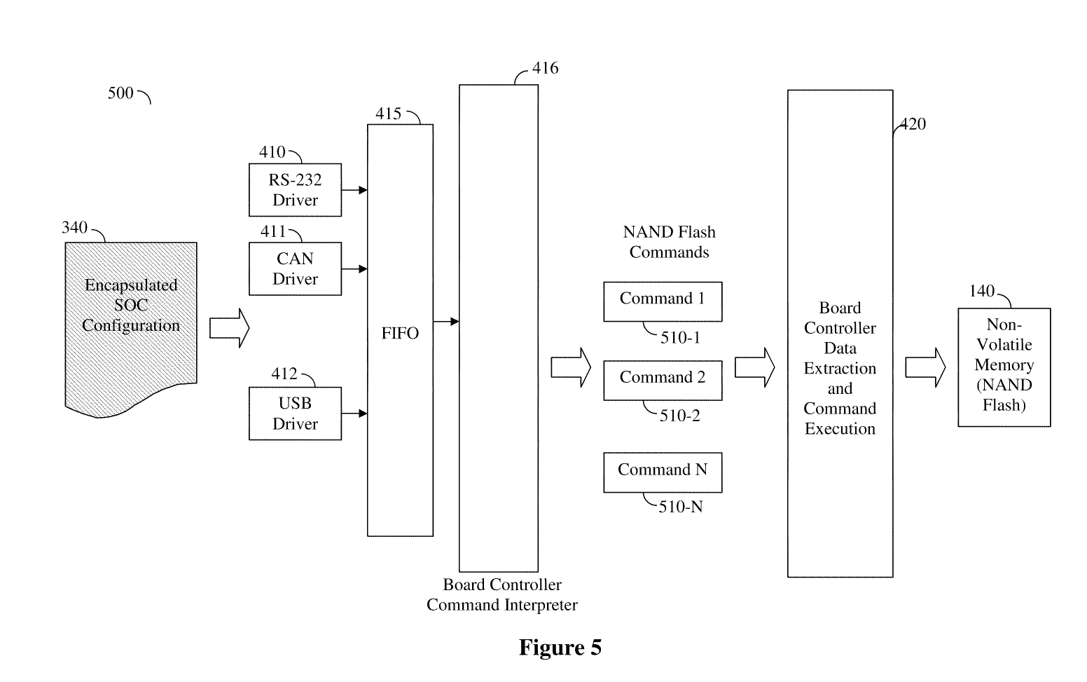

Reference is now made to FIG. 5, where a schematic diagram 500 showing the storage of the encapsulated SOC configuration file using a NAND Flash as an exemplary Non-Volatile Memory is shown. The encapsulated concatenated SOC configuration file 340 is received over a communications link, such as, but not limited to, RS-232, CAN bus or USB. The Board Controller interface to the communications link is controlled by an appropriate communications driver, such as the exemplary driver 410 for the RS-232 link, driver 411 for the CAN Bus, and driver 412 for the USB driver. These drivers handle the link protocol, and deliver the encapsulated concatenated SOC configuration file 340 to FIFO 415. The Board Controller 130 uses the Board Controller Command Interpreter 416 to read the concatenated SOC configuration file content from the FIFO, and to disassemble the configuration commands. The commands and data for storing configuration to the NAND Flash are shown as commands 510-1, 510-2 through 510-N. The Board Controller 130 uses the Board Controller Data Extraction and Command Execution 420 to extract the commands, and to process each command for the Non-Volatile Memory 140.

The SOC Module configuration is specified through sets of commands, such as those shown in the above figures. The configuration command set includes commands for status request and response, Download Initialization, Upload Initialization, and Data Transfer. Status requests include the retrieval of module information and platform status including, but not limited to, board and module voltages and temperature. Using this command set, operations such as initialization and writing configuration to Programmable Logic modules (such as the exemplary PLM Module 210), data read and write for Core Module 230 configuration data read and write to Core memory, data read and write to Non-Volatile Memory 140 (such as the exemplary NAND Flash Module), data read and write for functional modules, and data read and write to and from the Board Controller 130 memory map are performed. Transfer of configuration data to a module is performed through the Data Download Init-Data sequence. In this command sequence, the Data Download Init specifies the destination device and address for the transfer, followed by the data command which encapsulates the data. These command frames are combined to build higher-level configuration functionality. In the case of Programmable Logic configuration, the command data includes the compiled description of electronic circuits, which are generated using popular electronic design automation (EDA) tools. These descriptions, referred to in the art as “intellectual property” of the circuit or IP, is expressed as a hardware description following the place and route design steps, such as compiled Register Transfer Level or Netlist descriptions.

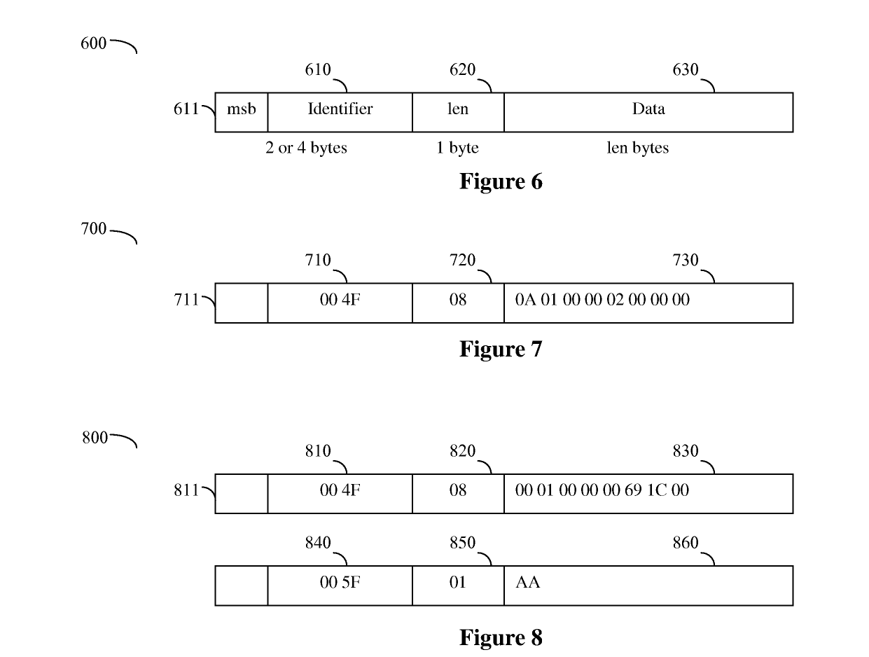

Reference is now made to FIG. 6, where a schematic diagram showing the structure of an exemplary SOC platform configuration command frame 600 is shown. The command structure is comprised of an Identifier field 610, a Length Field 620 and the Data field 630. The Identifier Field 610 indicates the type of the command, and the source or destination for the command. This field may be composed of 2 bytes in a standard frame or 4 bytes in an extended frame. The command frame starts by the most-significant-bit 611. The Length Field 620 indicates the number of following bytes in the Data Field for the command. This field is composed of one byte. The Data Field 630 contains the data and execution information for the command. This field is composed of a number of bytes indicated by the length field. In the case of CAN bus messages, the Identifier field is enclosed in the identifier part of the CAN message.

Reference is now made to FIG. 7, where a schematic diagram showing the structure of an exemplary Data Download Init command frame 700 to the NAND Flash, used as an exemplary Non-Volatile Memory 140, for erasing 1 sector is shown. The Identifier Field 710 has the value 00 4F and indicates a Data Download Init command. The Length Field 720 has the value 08 and indicates 8 following bytes in the Data Field. The Data Field 730 has the data for a NAND Flash erase operation of one sector starting at sector 2.

Reference is now made to FIG. 8, where a schematic diagram showing the structure of an exemplary Data Download Init command frame and Data Download command frame sequence for writing data to the Clock Generation unit 800 is shown. The Identifier Field 810 of the first command has the value 00 4F and indicates a Data Download Init command. The Length Field 820 has the value 08 and indicates 8 following bytes in the Data Field. The Data Field 830 indicates a Clock Generator Module write operation. In the Data command, the Indicator Field 840 has the value 00 5F indicating a data command. The Length Field 850 has the value ‘01’ indicating one byte of data. The Data Field 860 has the value AA which is the hexadecimal value written to the Clock Generator Module.

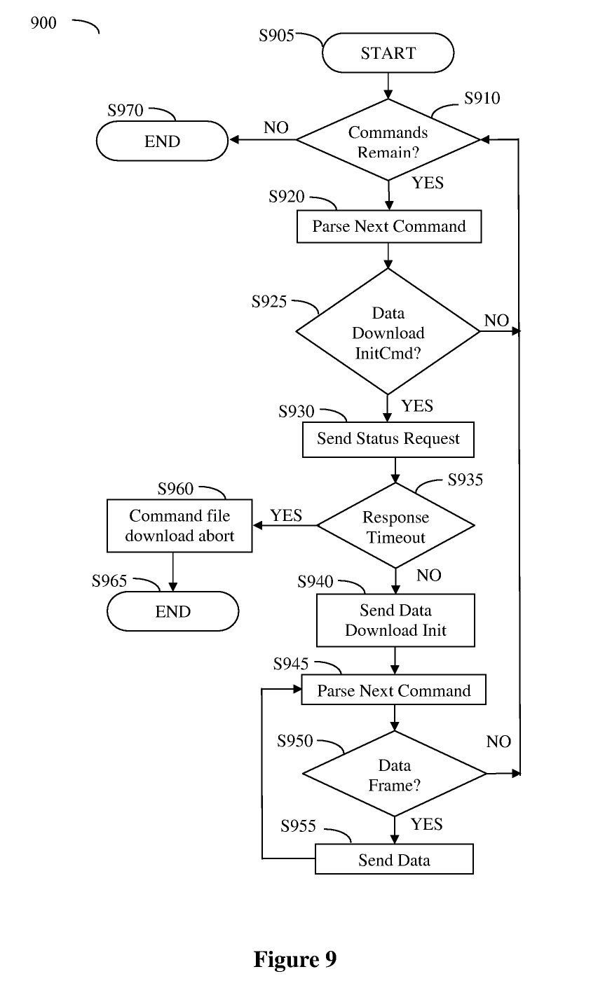

Reference is now made to FIG. 9, where a flowchart 900 of the Host Computer processing for the Data Download Init Data Download command sequence is shown. At S910 the Host Computer 160 checks that commands remain in the concatenated SOC configuration file 330. If commands remain, processing continues at S920. At S910, if commands do not remain in the file for transmission, then processing ends at S970. At S920 the Host Computer 160 execution parses the next command from the Concatenated SOC Configuration file. At S925, if the next command is a Data Download Init command, then the Host Computer 160 executes S930 and sends a Status Request to the Board Controller 130; otherwise, execution continues with S910. At S935, if the Board Controller 130 fails to respond to the Status Request within a timeout period, the execution proceeds to S960 which aborts the command file processing and ends processing thereafter; otherwise, the Board Controller 130 has responded to the Status Request with a response of Ready, and execution proceeds with S940. At S940, the Host Computer 160 sends the Data Download Init command over the communications link, to the Board Controller 130. This is followed by S945 where the Host Computer 160 parses the next command from the Concatenated SOC Configuration file. At S950, if the parsed command is a data command frame, the method continues with S955; otherwise, execution continues with S910, which tests if commands remain to be processed. At S955, the Host Computer 160 sends the Data command over the communications link. Execution returns to S945, which parses the next command. The process continues until all the commands in the Concatenated SOC Configuration file are processed.

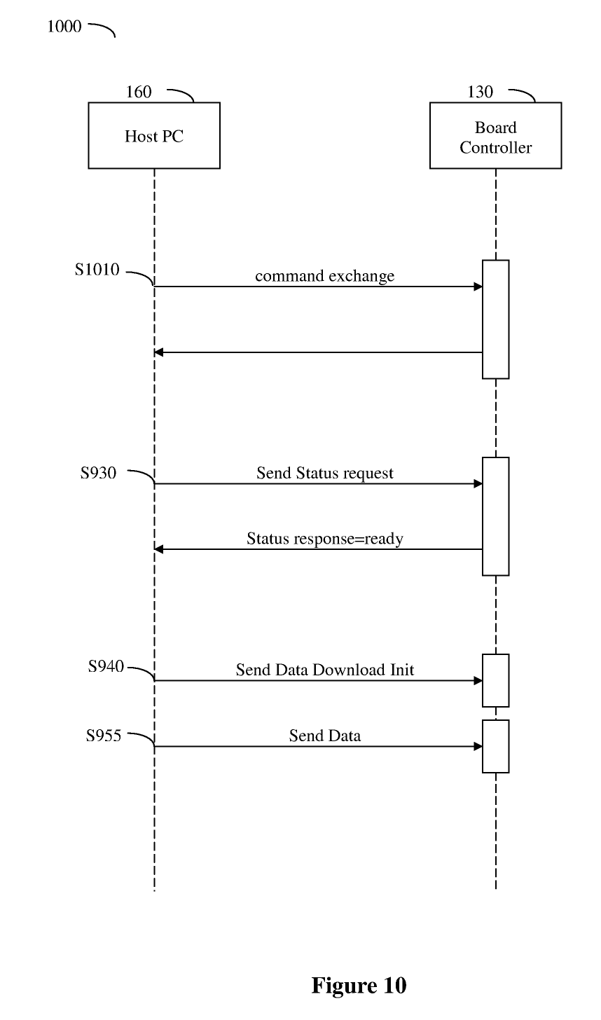

Reference is now made to FIG. 10, where a sequence diagram 1000 showing the exchange of commands and responses between the Host Computer 160 and the Board Controller 130. In this diagram, the exchange of commands and responses between the Host Computer 160 and the Board Controller 130 are shown in S1010. In the example of a Data Download command the Host Computer executes S930 and sends a Status Request to the Board Controller 130. If the Board Controller 130 responds to the Status Request with a response of Ready, execution proceeds with S940. At S940, the Host Computer 160 sends the Data Download Init command over the communications link to the Board Controller. This is followed by S955 where the Host Computer 160 sends the Data command over the communications link.

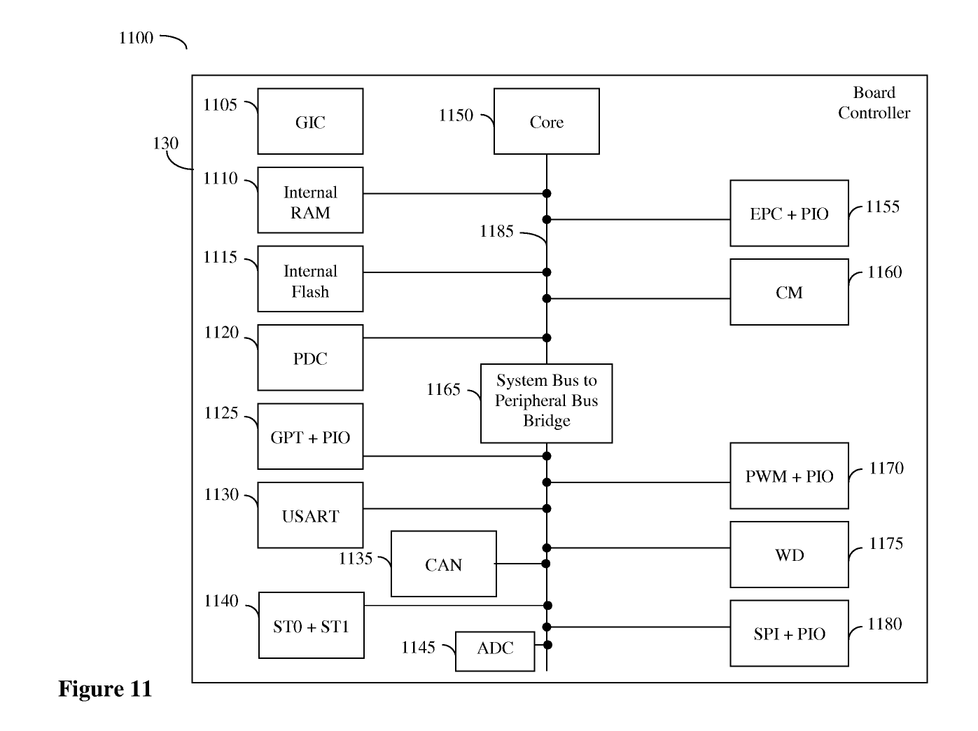

Reference is now made to FIG. 11, where a schematic diagram 1100 of the Board Controller 130 in a preferred but non-limiting embodiment is shown. In this diagram, Board Controller 130 is comprised of functional modules, a system bus and a peripheral bus. The generic interrupt controller (GIC) Module 1105 manages internal and external interrupts to the Board Controller Core Module 1150. The internal RAM module 1110 is used by the Board Controller Core Module 1150 for processing the Board Controller methods. The internal Flash module 1115 is used for storage of code for the Board Controller Core Module 1150. The peripheral data controller (PDC) Module 1120 enables data exchanges from and to memory regions and to and from functional modules. Exemplary functional modules include but are not limited to analog-to-digital converters (ADC), universal synchronous/asynchronous receiver/transmitters (USART) and serial peripheral interface (SPI) bus devices. The general purpose timer (GTP) and the Peripheral I/O (PIO) controller module 1125, is responsible for task scheduling ticks and software managed timeouts, and for programmable I/O for I2C Bus 270 emulation. The I2C Bus emulation is used to control on-board modules on the SOC Module 110, such as I/O Expander Module 260 and Clock Generation Module 240. The USART module 1130 is used for command exchange between the Board Controller 130 and the Host Computer 160 using an RS-232 link. The CAN Module 1135 is used for command exchange over the high speed CAN bus 170 to other SOC Modules and devices. The simple timer module 1140 includes software programmable timers. The Analog-to-Digital Converter Module 1145 is responsible for platform voltage and temperature measurements. The Core Module 1150 executes the Board Controller software, such as the Command Interpreter 416, the Data Extraction and Command Execution 420 and the communications link drivers RS-232 Driver 410, CAN Driver 411 and USB Driver 412. The EPC PIO Module 1155 is the interface to Parallel Bus 220, such as the FPGA Module 210, as well as to the USB Controller for the USB link to the Host Computer 160, and to the Non-Volatile Memory 140. The Module also controls FPGA configuration I/O, and is responsible for IEEE 1149.1 JTAG emulation functions for the JTAG ports 250 such as TAP control and multiplexing of multiple boundary scan paths. The CM Module 1160 is a Clock Manager that provides a clock input for the system. The PWM+PIO Module 1170 is a Pulse Width Modulation device, used for board fan control. The module's peripheral I/O controller is used for the I2C bus multiplexer control. The WD Module 1175 is a Watchdog Timer used to detect a non-responding system. The SPI+PIO Module 1180 is a Peripheral I/O controller used for JTAG emulation. The Board Controller 130 is connected to the above modules via a System Bus 1185, and uses a System Bus to Peripheral Bus Bridge Module 1165 for accessing the modules by the Core Module 1150 software.

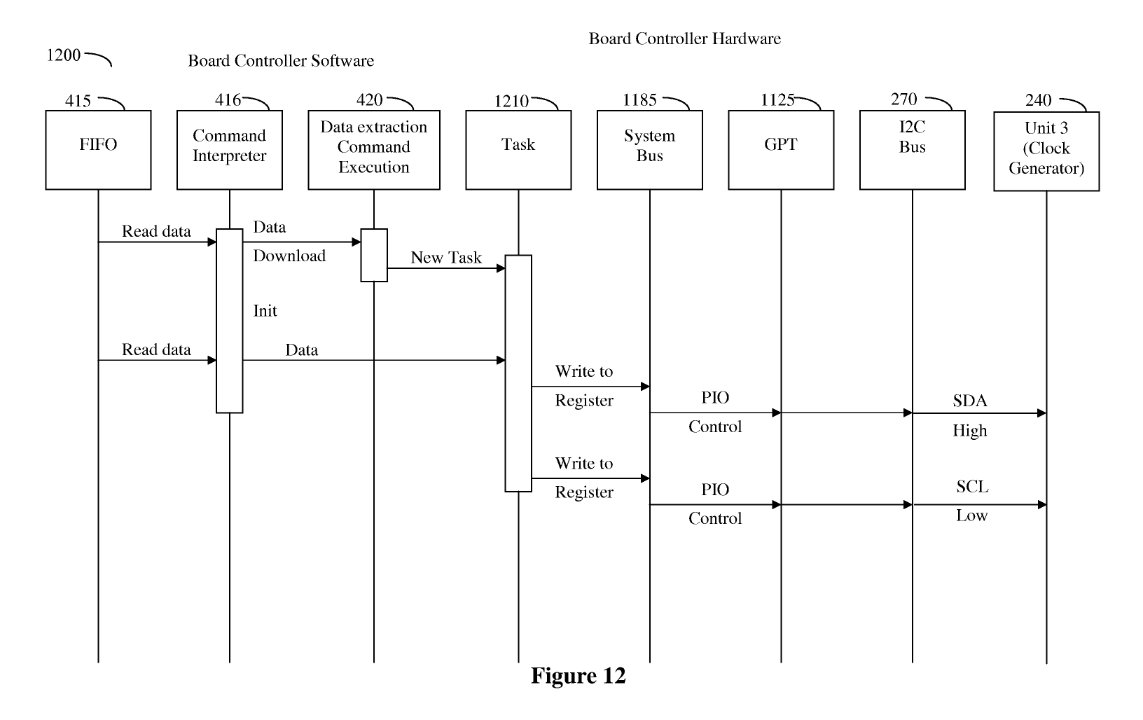

Reference is now made to FIG. 12, where a sequence diagram 1200 showing an exemplary processing of configuration commands for the Clock Generator Module 240 by the board controller software and hardware components is shown. In this diagram, the Board Controller Core 1150 executes software routines, and uses the interfaces to the Board Controller Modules to control the peripheral bus and Clock Generator Module. The Board Controller executes the Command Interpreter 416 routine to read Concatenated SOC Configuration file data from FIFO 415. The Board Controller executes the Command Interpreter 416 routine to disassemble the commands, passing the Data Download Init command frame to the Board Controller Data Extraction and Command Execution 420 routine. The Board Controller executes the Data Extraction and Command Execution 420 routine which process the Data Download Init command, and requests a new Task 1210 routine to process the following data command. The Board Controller Command Interpreter 416 routine reads the Data command from the FIFO, and disassembles the command, passing the Data command frame to the Task 1210 routine. The Board Controller executes Task 1210 routine, which receives the Data command, identifies the command as a Clock Generator Module command, and processes the data field of the command. The Task 1210 routine writes the data to the Clock Generator Module 240 through the I2C Bus 270. The I2C Bus is accessed by the Core Module 1150 through System Bus 1185 mapped registers. The Core Module 1150 writes data to the GPT+PIO Module 1125. The GPT+PIO Module 1125 Peripheral I/O Controller generates the SDA and SCL signals of the I2C bus 270 to the Clock Generator Module 240.

Thus the present invention has a number of aspects, which aspects may be practiced alone or in various combinations or sub-combinations, as desired. While a preferred embodiment of the present invention has been disclosed and described herein for purposes of illustration and not for purposes of limitation, it will be understood by those skilled in the art that various changes in form and detail may be made therein without departing from the spirit and scope of the invention as defined by the full breadth of the following claims.

What is claimed is:

1. A method for configuring a System-On-Chip emulation platform comprising:
sending at least one configuration command to the emulation platform where each configuration command is comprised of at least:
a command type;
an identifier of a functional module of the platform that is to be configured by said each command; and
configuration data.

2. The method of claim 1, wherein said functional modules are selected from a group of: programmable logic modules and field programmable gate arrays modules.

3. The method of claim 1, further comprising:
sending said configuration commands to a plurality of connected System-On-Chip platforms.

4. The method of claim 1, further comprising:
preparing said configuration commands on a host computer.

5. The method of claim 4, further comprising:
construction of at least one configuration command;
assembly of said at least one configuration command into at least one configuration file; and
aggregation of said at least one configuration file to a concatenated configuration file.

6. The method of claim 5, further comprising:
preparation of said concatenated command file into an encapsulated configuration file for delivery to non-volatile memory.

7. A method for processing configuration commands of a System-On-Chip emulation platform comprising:
receiving the configuration commands;
extracting a command field and data from each command of said configuration commands; and
processing each said configuration command.

8. The method of claim 7, wherein said processing of each said configuration command further comprises:
executing one or more routines for at least an emulation platform functional module that is to be configured by each said configuration command.

9. An apparatus for configuring a prototyping platform of a System-On-Chip comprising:
a Board Controller Module;
a first communications interface to a host coupled to said Board Controller Module; and
at least one functional module of the prototyping platform coupled to said Board Controller Module through a second communication interface;
such that configuration of said at least one functional module is performed by sending configuration commands directed for the configuration of said at least one functional module from the host to the Board Controller Module.

10. The apparatus of claim 9, wherein said Board Controller Module is enabled to receive said configuration commands, extract a command filed and data from each configuration command, and process each said configuration command.

11. The apparatus of claim 9, further comprising: one or more core processing modules coupled to said Board Controller Module.

12. The apparatus of claim 9, further comprising: one or more programmable logic modules coupled to said Board Controller Module.

13. The apparatus of claim 12, wherein at least one of said one or more programmable logic modules is a Field Programmable Gate Array (FPGA).

14. The apparatus of claim 9, further comprising: non-volatile memory coupled to said Board Controller Module for storage of configuration and board control logic.

15. The apparatus of claim 9, further comprising: a bus for enabling an interface to at least one other said apparatus.

16. The apparatus of claim 15, where said bus is a control area network (CAN) bus.

17. The apparatus of claim 9, further comprising:
a parallel bus coupled to between said Board Controller Module and the at least one functional module.

18. The apparatus of claim 9, wherein said Board Controller Module is enabled to emulate a Joint Test Action Group (JTAG) to couple a functional module that supports JTAG test ports.

19. The apparatus of claim 9, further comprising:
an inter-integrated circuit (I2C) bus coupled to said Board Controller Module and further enabled to be coupled to at least one functional module.

20. The apparatus of claim 9, wherein said Board Controller Module is enabled to provide communications between said Board Controller Module and a host computer for at least an exchange of commands and responses.
